(19) United States
(12) Patent Application Publication
(10) Pub. No.: US 2014/0374566 A1
(43) Pub. Date: Dec. 25, 2014

(54) ATTACHMENT PYLON FOR AN UNDUCTED FAN

(71) Applicant: SNECMA, Paris (FR)

(72) Inventors: Rasika Fernando, Paris (FR); Nicolas Mehier, Montreuil Sous Bois (FR); Fabien Monti, Antony (FR); Nicolas Sirvin, Brunoy (FR)

(73) Assignee: SNECMA, Paris (FR)

(21) Appl. No.: 14/364,981

(22) PCT Filed: Dec. 12, 2012
(86) PCT No.: PCT/FR2012/052905

§ 371 Date: Jun. 12, 2014

(30) Foreign Application Priority Data
Dec. 12, 2011 (FR) 1161457

(51) Int. Cl. B64D 27/26

(52) U.S. Cl. CPC B64D 27/26; B64D 2027/262
USPC 248/554

(57) ABSTRACT

A pylon configured to secure a turbine engine to a structural element of an aircraft, the pylon including a streamlined profile defined by two opposite faces and extending longitudinally between a leading edge and a trailing edge, and at least a first one of the two faces presenting at least locally a succession of non-through hollows and of bumps.

### FIELD OF THE INVENTION

The present description relates to an attachment pylon (or mast) for a turbine engine, in particular a turboprop, and in particular a turboprop having at least one set of unducted blades.

The present description also relates to a device for an aircraft comprising such a turbine engine and a pylon.

### STATE OF THE PRIOR ART

In known manner, an attachment pylon is suitable for securing a turbine engine to a structural element of an aircraft. For example, when the aircraft in question is an airplane, the turbine engine may be suspended from the pylon which is fastened under a wing element of the airplane, or else it is attached to the pylon (e.g. laterally relative to the pylon), which pylon is fastened to a fuselage element of the airplane.

In addition and in known manner, in order to optimize the aerodynamic performance of the aircraft in operation, such a pylon presents a streamlined profile defined by two opposite faces and extending longitudinally between a leading edge and a trailing edge.

The shape of this streamlined profile gives rise to a particular flow field that may be found to be unfavorable for other aspects of the performance of the aircraft, in particular its noise performance, and/or mechanical performance, and/or the efficiency of its turbine engine.

There therefore exists a need to optimize flows around the streamlined profile of the pylon, but without that degrading its aerodynamic performance.

### SUMMARY OF THE INVENTION

A first aspect of the present description provides a pylon suitable for securing a turbine engine to a structural element of an aircraft, said pylon having a streamlined profile defined by two opposite faces and extending longitudinally between a leading edge and a trailing edge, and at least a first one of the two faces presenting at least locally a succession of non-through hollows and/or of bumps.

The presence of such a succession of non-through hollows and/or bumps on at least a first one of the two opposite faces of the streamlined profile serves to modify locally the flows around the pylon, but without significantly degrading its aerodynamic performance, which remains practically unchanged overall because the impact of the hollows and/or bumps is local only.

In the present description, the terms “longitudinal” or “longitudinal direction” are used to designate the direction along which an engine axis of the turbine engine extends (corresponding to the axis of rotation of a rotor of the turbine engine), when the engine is fastened to the pylon. Consequently, this longitudinal direction corresponds to the general flow direction of the stream surrounding the pylon under normal conditions of use.

In particular, the streamlined profile of the pylon may be defined longitudinally, in a flow direction of the stream, between the leading edge and the trailing edge.

Furthermore, in the present description, the term “non-through hollow” is used to designate a hollow formed in one of the two opposite faces of the pylon, which hollow does not pass through the entire thickness of the material forming said at least one of the two opposite faces (i.e. the hollow does not perforate the material).

Said material may constitute a skin of the pylon, with the skin forming the thickness between said at least one of the two opposite faces of the pylon and an empty volume or void inside the pylon, when the pylon is designed to have at least a cavity portion. Under such circumstances, the hollows formed in said one of the two opposite faces do not open out into the interior void of the pylon.

Said material may otherwise form the thickness proper of the pylon and extend between the two opposite faces of the pylon, when at least a portion of the pylon is designed to be made of solid material. Under such circumstances, the hollows formed in said at least one of the two opposite faces do not open out into the other one of these two faces.

Furthermore, attempts may be made to further reduce the impact of the hollows and/or bumps on the overall aerodynamic behavior of the pylon.

Thus, in certain embodiments, the pylon may be such that the offset generated locally by each hollow/bump relative to the level of the first face of the pylon in the proximity of the location where the hollow/bump is formed does not exceed 0.3 times (and in particular 0.2 times) the maximum distance of the spacing between the two opposite faces of the pylon (which maximum distance may correspond to the maximum thickness of the pylon).

In addition, in certain embodiments, the pylon may be such that in the longitudinal direction, the ratio of the maximum dimension of each hollow/bump relative to the maximum spacing distance between the leading edge of the pylon and its trailing edge is less than 0.15 (in particular less than 0.1).

Furthermore, attempts may be made to further optimize the flows around the pylon.

Thus, in certain embodiments, the pylon may be such that the hollows and/or bumps extend longitudinally at least in the vicinity of an edge of the profile selected from its trailing edge and its leading edge.

Furthermore, in certain embodiments, the pylon may be such that said first face has first and second zones presenting respectively first and second distinct distributions of hollows and/or of bumps.

In the present description, the term “first and second distinct distributions of hollows and/or bumps” is used to mean that the hollows and/or bumps are in distributions that are not identical with each other concerning spatial distribution and/or concerning the shapes of the hollows and/or bumps involved as the case may be in the first and second zones.

In certain embodiments, the pylon may be such that the first and second zones extend transversely and are longitudinally adjacent.

In certain embodiments, the pylon may be such that the first distribution is a homogeneous distribution of hollows and/or bumps, while the second distribution is an inhomogeneous distribution of hollows and/or bumps.

In the present description, the term “uniform distribution” is used to designate a distribution of hollows and/or bumps that are spaced apart substantially regularly along at least one given main direction, and in particular along the longitudinal direction and/or along the transverse direction.

Conversely, the term “non-uniform distribution” is used to designate a distribution in which the distance between two adjacent local deformations varies significantly along at least one main direction, in particular along the longitudinal direction and/or along the transverse direction.

In certain embodiments, the first zone may present a uniform distribution of hollows.

In certain embodiments, the second zone may present a non-uniform distribution of bumps.

In certain embodiments, the pylon may be such that the hollows and/or the bumps of the first and second distributions are of respective distinct shapes.

Thus, the first and second distributions are considered as having distinct respective shapes merely if one of the two distributions (the first or the second) uses hollows while the other distribution (the second or the first) uses bumps. For example, the pylon may be such that a selected one of the two zones, the first zone or the second zone, presents a succession of hollows, while the other zone presents a succession of bumps.

In another embodiment, the pylon may be such that one of the two zones, selected from the first zone and the second zone, presents a succession of hollows having a first shape, while the other zone presents a succession of hollows having a second shape that is distinct from the first shape.

In yet another embodiment, the pylon may be such that a selected one of the first and second zones presents a succession of bumps having a first shape, while the other zones presents a succession of bumps having a second shape that is distinct from the first shape.

In certain embodiments, the hollows may be spaced apart periodically along at least two main directions that are not collinear.

In certain embodiments, the first distribution may define an equal distribution of sockets constituting non-through hollows, thereby conferring isotropic flow properties to the first zone.

In certain embodiments, the bumps may be elongate in respective long directions that differ from a given bump to the or each other bump that is directly adjacent thereto.

In certain embodiments, the second distribution may comprise bumps of streamlined profile that are elongate so as to provide a vortex generator.

Furthermore, in certain embodiments, the pylon may be such that the hollows and/or bumps are formed integrally with the first face.

In certain embodiments, the edges of the hollows and/or of the bumps that are situated at the junction of the first face may be rounded.

In certain embodiments, said at least first one of the two faces may present, at least locally, and in the stream flow direction (the longitudinal direction), a succession of at least one non-through hollow and at least one bump.

In certain embodiments, said at least first one of the two faces may present, at least locally, and in the stream flow direction, a succession of at least one non-through hollow and then at least one bump. Thus, going along this stream flow direction, at least one hollow is encountered initially followed by at least one bump.

In certain embodiments, said at least first one of the two faces may present, at least locally, and in a first travel direction along the stream flow direction, a succession of at least one non-through hollow followed by at least one bump.

In certain embodiments, said first travel direction corresponds to the flow direction of the stream, i.e. the travel direction along the longitudinal direction going from the leading edge and towards the trailing edge (i.e. going from upstream to downstream relative to the pylon).

In certain embodiments, said at least first one of the two faces may present at least locally a succession of non-through hollows and a succession of bumps, said first face having first and second zones that extend transversely and that are longitudinally adjacent, the second zone being that one of said first and second zones that is longitudinally closer to the trailing edge, the succession of hollows being formed in the first zone, while the succession of bumps is formed in the second zone

In certain embodiments, said first travel direction is opposite to said flow direction of the stream.

Furthermore, in certain embodiments, the pylon may be such that each of the two opposite faces of the profile presents an analogous succession of bumps and/or hollows.

Under such circumstances, in certain embodiments, one or more of the above characteristics described in association with the first of the two opposite faces of the profile may be used in association with the other of these two faces.

Furthermore, in certain embodiments, the pylon may be adapted to secure a turboprop as the turbine engine to a structural element of an aircraft.

In certain embodiments, the turboprop may include at least one set of unducted blades (which type of turboprop is also known as an open rotor turboprop).

Under such circumstances, the or each set of unducted blades may be mounted at the rear of the engine.

The pylon may then be suitable for being fastened in front of the or each set of unducted blades (in front being relative to the travel direction of the aircraft).

As a result of positioning the pylon in this way relative to the unducted blades of the turboprop, the pylon in operation generates a wake that interacts with the blades situated behind it, thereby generating so-called “interaction” noise.

More precisely, the thickness of the boundary layer may increase progressively in the travel direction of the aircraft, thereby producing a speed deficit at the trailing edge of the pylon, which is responsible for eddies that are “chopped” by the blades of the turboprop, thereby producing noise.

Under such circumstances, the fact that in accordance with the present description at least a first one of the two opposite faces of the pylon presents at least locally a succession of hollows and/or bumps can be used to advantage, in certain embodiments, to reduce the intensity of the wake, by increasing mixing between the layers of air flowing in the vicinity of this first face of the pylon. These hollows and/or bumps may make the boundary layer more turbulent, thereby increasing mixing of the streams of air so as to reduce the speed deficit in the wake of the pylon, thereby giving rise to a reduction in the level of sound generated by the turboprop in operation, but without degrading overall aerodynamic performance.

In certain embodiments, the hollows and/or bumps may extend longitudinally between the vicinity of the trailing edge of the pylon and a location on the first face of the pylon that is designed to generate a minimum thickness of boundary layer. This arrangement serves to obtain a good compromise between noise performance and aerodynamic performance.

In certain embodiments, the pylon may be such that its profile is defined transversely between a distal edge for fastening to the front of the turboprop and a proximal edge for fastening to the structural element of the aircraft, and such that the succession of hollows and/or bumps extends transversely at least between the distal edge of the pylon and the location of the projection onto the pylon of the path followed by the tips of the blades of said blade set when the pylon is fastened to the turboprop.

In the present description, the terms “transversely” or “transverse direction” are consequently used to mean the direction perpendicular to the longitudinal direction and corresponding to the direction along which the proximal and distal edges of the pylon are spaced apart.

In the present description, the adjectives “proximal” and “distal” are used with reference to the point(s) where the pylon is attached to the structural element of the aircraft.

Furthermore, in certain embodiments, the pylon may be such as to be suitable for securing the turbine engine to an airplane, when the aircraft is an airplane.

Under such circumstances, the pylon may be such as to be suitable for being fastened to a structural element of the airplane, by way of example, to an element selected from a wing element or a fuselage element of the airplane.

Furthermore, a second aspect of the present description relates to a device for an aircraft, the device comprising a turbine engine, and a pylon according to the above-mentioned first aspect of the present description, by means of which pylon the turbine engine is suitable for being secured to a structural element of the aircraft.

In certain embodiments of the device, the pylon may include one or more characteristics from all of the characteristics mentioned above in the context of the first aspect of the present description.

For example, in certain embodiments, the device may be such that the turbine engine is a turboprop having at least one set of unducted blades, and such that the pylon is suitable for being fastened ahead of the blade set.

In certain embodiments, the device may be such that the profile of the pylon is defined transversely between a distal edge for fastening to the front of the turboprop and a proximal edge for fastening to the structural element of the aircraft, and such that the succession of hollows and/or the succession of bumps extends transversely at least between the distal edge of the pylon and the location of the projection on the pylon of the path followed by the tips of the blades of said blade set.

The above-mentioned characteristics and advantages, and others, appear better on reading the following detailed description of embodiments that have no limiting character and that are proposed merely by way of illustration. This detailed description refers to the accompanying drawings.

### BRIEF DESCRIPTION OF THE DRAWINGS

The accompanying drawings are diagrammatic and not to scale, and they seek above all to illustrate the principles mentioned in the present description. In the accompanying drawings:

FIG. 1 is a diagrammatic longitudinal section view of an embodiment of a turbine engine in accordance with the present description;

FIG. 2A is a plan view in a plane defined by the longitudinal and transverse directions showing an embodiment of a device for an aircraft with its pylon in accordance with the present description;

FIG. 2B is a fragmentary enlargement in perspective and in section of a portion of the pylon shown in FIG. 2A; and

FIG. 2C is a section view in a plane perpendicular to the transverse direction of the pylon shown in FIG. 2A.

### DETAILED DESCRIPTION OF EMBODIMENTS

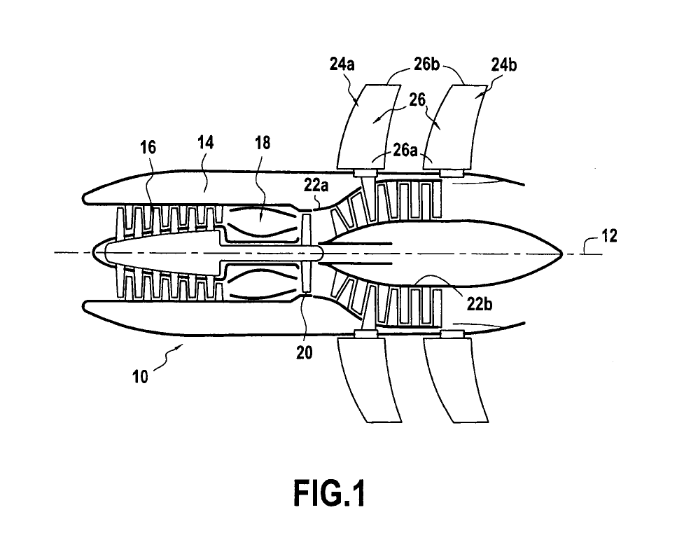

FIG. 1 is a highly diagrammatic view of an embodiment of a turbine engine in accordance with the present description.

In this embodiment, the engine comprises a turboprop 10.

In this embodiment the turboprop 10 has at least one set of unducted blades, and in particular it has two sets so that the turboprop 10 is of the type having two pusher propellers.

Such a turboprop 10 is known and is therefore not described in detail. Typically it comprises specifically an engine axis 12 with an annular nacelle 14 arranged coaxially around the axis 12. It also comprises, from upstream to downstream (in the flow direction of the air stream when the turboprop is placed in normal conditions of use): a compressor 16, a combustion chamber 18, and a turbine 20 having two contrarotating rotors 22a and 22b. In this embodiment the engine axis 12 thus corresponds to the axis of rotation of the two rotors 22a and 22b.

The turboprop 10 also comprises a first blade set 24a referred to as the upstream (or front) set, and a second blade set 24b referred to as the downstream (or rear) set. Such blades are said to be fan blades 26. In this example they are adjustable in pitch. They are situated at the rear of the turboprop. Each of these fan blades 26 presents a root 26a and a tip 26b, and they are driven in rotation by the respective rotors 22a and 22b. Thus, in this embodiment, the blades of the first and second blade sets 24a and 24b are contrarotating.

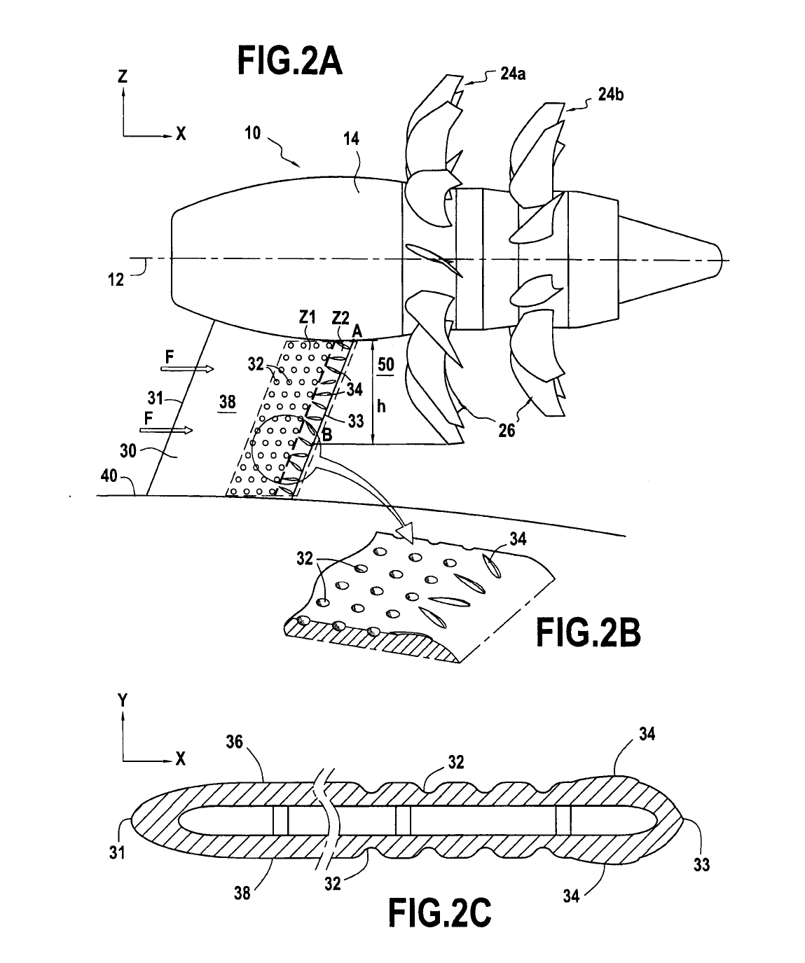

As shown in FIG. 2A, the turboprop 10 is for fastening to a pylon 30 in order to form a device for an aircraft suitable for being secured to a structural element of the aircraft. The turboprop 10 may consequently be secured to the structural element by means of the pylon 30.

In the embodiment shown, the pylon 30 is suitable for being fastened to a structural element of an airplane when the aircraft is constituted by an airplane. In this embodiment, the structural element is directed to be a fuselage element 40 of the airplane.

In particular, the pylon 30 may be adapted to be fastened to the rear portion of the airplane fuselage, behind the cabins, and in particular close to its tail cone.

In this embodiment, the pylon 30 presents a streamlined profile that is defined by two opposite faces 36 and 38 (more clearly visible in FIG. 2C) and that extends longitudinally between a leading edge 31 and a trailing edge 33 (i.e. it extends parallel to the above-described engine axis 12 of the turboprop 10, when the turboprop is fastened to the pylon 30, or indeed along the general direction F in which the stream surrounding the pylon 30 travels under normal conditions of use, which direction is also given reference X in FIGS. 2A and 2C).

In the embodiment shown (see in particular FIG. 2C), and for reasons of optimizing the streamlining of the pylon 30, each of the two opposite faces 36 and 38 of the pylon presents in the longitudinal direction X: a portion that is substantially more plane (in particular that is substantially plane in this embodiment), an upstream portion that is more curved and that extends the central portion from its upstream end to the leading edge 31, and a downstream portion that is more curved and that extends the central portion downstream therefrom to the trailing edge 33.

Thus, in this embodiment, the leading and trailing edges 31 and 33 both serve as locations where the two opposite faces 36 and 38 of the pylon 30 join together via their respective upstream and downstream portions that are more curved.

In addition, in this embodiment, the respective central portions of the two faces 36 and 38 are substantially mutually parallel.

Furthermore, in this embodiment, the pylon 30 is hollow in part, as shown in FIG. 2C.

More particularly, the pylon 30 comprises a skin that is made firstly of the material forming the thickness between the first face 38 of the two opposite faces of the pylon and an internal void arranged between these two faces 36 and 38, and secondly by the material forming the thickness of the other face 36 of these two faces and the internal void. As shown in FIG. 2C, it is possible optionally to place one or more spacer elements in this void for the purpose of stiffening the skin of the pylon 30, at least locally.

Furthermore, in this embodiment, the streamlined profile of the pylon 30 is defined transversely (in a direction Z perpendicular to the longitudinal direction X, and in this example perpendicular to the spacing direction Y of the two opposite faces 36 and 38 of the pylon) between a distal edge (constituting a tip of the pylon in this embodiment) for fastening to the turboprop 10, and a proximal edge (constituting a root of the pylon in this example) for fastening to the structural element of the aircraft.

Each of the proximal and distal edges of the pylon is fitted with a plurality of fasteners (not shown in the figures) for fastening the pylon firstly to the structural element of the aircraft (at the proximal edge of the pylon 30), and secondly for fastening the nacelle 14 of the turboprop 10 to the pylon 30 (at its distal edge). These fasteners are themselves well known and are therefore not described in detail. For example, they may involve mounting by means of a fork or by means of bolted connections.

In this embodiment, given the presence of the first and second sets 24a and 24b of fan blades at the rear of the turboprop, the pylon 30 is fastened to the front of the nacelle 14.

In this embodiment, when the turboprop 10 is fastened to the pylon 30, the pylon is located upstream from the unducted blades of the turboprop (upstream relative to the general travel direction of the stream F).

From among the leading edge 31 and the trailing edge 33, the trailing edge 33 is that one of the two edges of the pylon that is the closest in the longitudinal direction X to the blade sets 24a and 24b.

In this embodiment, the trailing edge 33 is also directly adjacent to the upstream blade set 24a.

As a result, the pylon 30 in operation gives rise to a wake having at least a portion that interacts with the blades 26 of the turboprop 10, and more particularly with the blades of the upstream set 24a.

In order to optimize this interaction between the wake induced by the pylon 30 and the blades 26 situated behind it (downstream therefrom), provision is made in this embodiment for at least a first of the two opposite faces 36 and 38 of the pylon 30 to present, at least locally, a succession of non-through hollows 32 and/or of bumps 34.

More particularly, the first face 38 has first and second zones Z1 and Z2 respectively presenting first and second distinct distributions of hollows 32 and/or of bumps 34.

In this embodiment, these first and second zones Z1 and Z2 extend in the transverse direction Z and they are adjacent in the longitudinal direction X.

In this embodiment, the second zone Z2 is that one of the two zones that is closer to the trailing edge 33 in the longitudinal direction X. Consequently, this second zone Z2 is located downstream from the first zone Z1 in the longitudinal direction X.

More particularly, this second zone Z2 extends longitudinally between a location close to the trailing edge 33 and a location of the transition between the first and second zones Z1 and Z2.

Furthermore, in this embodiment, this transition is located in such a manner as to correspond substantially with the location of the junction between the central portion and the downstream more curved portion of the first face 38.

In addition, the first zone Z1 is that one of the two zones that is further from the trailing edge 33 along the longitudinal direction X.

More particularly, this first zone Z1 extends longitudinally between the transition between the first and second zones Z1 and Z2, and a location close to the location where the boundary layer begins on the first face 38 of the pylon 30.

Thus, in this embodiment, the hollows 32 and/or bumps 34 extend longitudinally, at least in the vicinity of one of the edges of the profile selected from its trailing edge 33 and its leading edge 31. In this embodiment, the edge is specifically its trailing edge 33.

Furthermore, in the embodiment shown, the first face 38 of the pylon 30 presents, at least locally, a succession of non-through hollows, and simultaneously a succession of bumps.

More particularly, the first zone Z1 presents a succession of hollow 32 only.

As can be seen in FIG. 2C, these hollows 32 do not pass through the entire thickness of the skin of the pylon 30, so they do not open out into the interior void of the pylon. As a result the hollows 32 do not pierce the first face 38 in which they are formed.

Furthermore, in this embodiment, all of the hollows 32 formed in the first zone Z1 are identical to one another.

More particularly, each of these hollows 32 is in the shape of a socket, in particular a circularly symmetrical socket.

Furthermore, in this embodiment, the hollows 32 are distributed homogeneously in the first zone Z1.

More particularly, the hollows 32 are spaced apart periodically along at least one main direction.

In the embodiment shown, the hollows 32 are spaced apart periodically along two main directions, in particular the longitudinal direction X and another main direction that is not collinear with the direction X (and as shown in FIG. 2A, specifically a direction that is oblique relative to the longitudinal and transverse directions X and Z, e.g. a direction that is substantially parallel to at least a portion of the trailing edge 33).

As a result, in this embodiment, the distribution of hollows 32 in the first zone Z1 is homogeneous along these two main directions, the hollows 32 being regularly spaced apart along these two directions.

In this embodiment, in order to further increase the homogeneity of the distribution in the first zone Z1, the respective spatial periods along these two main directions are selected to be substantially equal. Nevertheless, it would not go beyond the ambit of the present description if that were not so.

Furthermore, it is also specified that it is possible, without going beyond the ambit of the present description, to replace the hollows 32 of the first zone Z1 with bumps, in particular bumps presenting relief that is inverted relative to that of the hollows 32, e.g. circularly symmetrical convex bumps, in order to obtain effects that are analogous to those procured by the hollows 32.

In addition, in the embodiment shown, the second zone Z2 presents a succession of bumps 34 only.

These bumps 34 are spaced apart along at least one main direction, and in particular along only one main direction in this embodiment, specifically the oblique direction mentioned above for the first zone Z1.

In this embodiment, each bump 34 presents a streamlined profile (in particular in the shape of a drop of water) so as to avoid degrading the streamlining of the pylon as a whole.

More particularly, each bump 34 is elongate in an long direction.

In the embodiment shown, the long direction of a given bump differs from the long direction of the or each bump that is directly adjacent thereto, such that the distance between two adjacent bumps varies, at least along the above-mentioned oblique direction.

This results in the distribution of the bumps in the second zone being inhomogeneous.

Furthermore, without going beyond the ambit of the present description, it is possible to replace the bumps 34 with hollows, e.g. hollows presenting relief that is inverted relative to the bumps 34.

In addition, since in the embodiment shown the hollows 32 of the first zone Z1 are circularly symmetrical, while the bumps 34 of the second zone Z2 are elongate, it can be seen that the hollows 32 and bumps 34 respectively distributed in the first and second zones Z1 and Z2 have respective distinct shapes in this embodiment.

Furthermore, in this embodiment, provision is made for the hollows 32 and the bumps 34 to be formed integrally with the first face 38, which is less expensive to achieve and serves to reduce the amount of matter that is shifted.

Furthermore, in this embodiment (see in particular FIG. 2C), the edges of the hollows 32 and/or of the bumps 34 situated at the junction of the first face 38 are rounded, thus making it possible to reduce the mechanical stresses induced by the presence of the hollows 32 and/or the bumps 34, and also serving to reduce the noise produced specifically by the flow over the first face 38.

In the embodiment shown, the hollows 32 are in the form of sockets in relief in the face 38 of the pylon, in its first zone Z1. This socketed portion of the surface serves to strengthen the turbulence in the boundary layer that gives rise to the wake downstream from the pylon 30. It gives rise to an increase in the mixing of the air streams, thereby making it possible to reduce the speed deficit in the wake of the pylon.

Furthermore, the distribution of bumps 34 presented in the second zone Z2 and the special shape of the bumps causes a vortex to be generated. In other words, the distribution in the second zone Z2 is structured as a vortex generator. By being placed downstream (in the longitudinal direction X) of the socketed surface portion and in the vicinity of the trailing edge 33 of the pylon, this vortex generator can thus continue with the work of mixing the streams of air that is initiated in the first zone Z1, by further amplifying the turbulence at the trailing edge. As a result of this combined work performed both by the hollows and by the bumps in the first and second zones Z1 and Z2 respectively, the intensity of the wake is reduced, so that the interaction noise generated by the blades of the upstream blade set 24a passing periodically through the wake is reduced.

Furthermore, the portion of the wake in the transverse direction Z that interacts most strongly with the blades 26 in this embodiment is the portion formed in the zone given reference 50 in FIG. 2A.

More particularly, this zone 50 extends in the transverse direction Z over the entire height h between two locations A and B that correspond respectively to the location A where the distal edge of the pylon 30 meets the turboprop 10, and the location B of the projection onto the pylon 30 of the path followed by the tips of the blades in the upstream set 24a (the projection being along a direction of the pylon parallel to the longitudinal direction X).

On the basis of this observation, the succession of hollows 32 and/or of bumps 34 in this embodiment is selected to extend transversely, at least between the distal edge of the pylon 30 and this location B of the projection.

More particularly, in this embodiment, the succession of hollows and/or bumps extends transversely over substantially the entire distance between the proximal and distal edges of the pylon 30.

Still more particularly, the first and second zones Z1 and Z2 both extend transversely over substantially the entire distance between the proximal and distal edges of the pylon 30.

Furthermore, in this embodiment, the other face 36 of the pylon 30 (the face opposite to the above-described first face 38) also presents, at least locally, a succession of non-through hollows and/or of bumps.

More particularly, and as shown in FIG. 2C, this other face 36 presents a succession of hollows and/or bumps analogous to that of the first face 38.

Still more particularly, this other face 36 presents first and second zones analogous to those of the first face 38.

In this example, the first and second zones of this other face 36 are offset a little in the longitudinal direction X relative to the corresponding zones of the first face 38, although this is not essential in the context of the present description.

The embodiments described in the present description are given by way of non-limiting illustration, and a person skilled in the art will find it easy in the light of this description to modify these embodiments or to envisage others, while remaining within the scope of the invention.

Furthermore, the various characteristics of these embodiments may be used on their own or in mutual combinations. When they are combined, these characteristics may be combined as described or in other ways, with the invention not being limited to the specific combination described in the present description. In particular, unless specified to the contrary, any characteristic described with any embodiment may be applied in analogous manner to any other embodiment.

1-10. (canceled)

11. A pylon configured to secure a turbine engine to a structural element of an aircraft, the pylon comprising:
a streamlined profile defined by two opposite faces and extending longitudinally between a leading edge and a trailing edge,
wherein at least a first one of the two faces comprises at least locally a succession of non-through hollows and bumps.

12. A pylon according to claim 11, wherein the hollows and/or the bumps extend longitudinally at least in a vicinity of an edge of the profile selected from the trailing edge and the leading edge of the pylon.

13. A pylon according to claim 11, wherein the first face includes first and second zones respectively presenting first and second distinct distributions of hollows and/or of bumps.

14. A pylon according to claim 13, wherein the first and second zones extend transversely and are longitudinally adjacent.

15. A pylon according to claim 13, wherein the first distribution is a homogeneous distribution of hollows and/or bumps, and the second distribution is an inhomogeneous distribution of hollows and/or bumps.

16. A pylon according to claim 13, wherein the hollows and/or the bumps of the first and second distributions are of respective distinct shapes.

17. A pylon according to claim 11, wherein the hollows and/or the bumps are formed integrally with the first face.

18. A device for an aircraft, the device comprising:
a turbine engine; and
a pylon configured to secure the turbine engine to a structural element of the aircraft, the pylon comprising a streamlined profile defined by two opposite faces and extending longitudinally between a leading edge and a trailing edge, wherein at least a first one of the two faces comprises at least locally a succession of non-through hollows and or bumps.

19. A device according to claim 18, wherein the turbine engine is a turboprop including at least one set of unducted blades, and wherein the pylon is configured to be fastened ahead of the blade set.

20. A device according to claim 19, wherein the profile of the pylon is defined transversely between a distal edge for fastening to a front of the turboprop and a proximal edge for fastening to the structural element of the aircraft, and
wherein the succession of hollows and the succession of bumps extend transversely at least between the distal edge of the pylon and a location of the projection on the pylon of a path followed by tips of the blades of the blade set.
